(19) United States
(12) Patent Application Publication
(10) Pub. No.: US 2010/0171466 A1
(43) Pub. Date: Jul. 8, 2010

(54) Lithium-ion batteries and methods of operating the same

(76) Inventors: Timothy Spitler, Fernley, NV (US); Ching-Chung Huang, Summit, NJ (US); Du Pasquler Aurelien, Red Bank, NJ (US)

Correspondence Address: Altairnano, Inc, 204 Edison Way, Reno, NV, 89502, US

(21) Appl. No.: 12/319,300

(22) Filed: Jan. 5, 2009

(51) Int. Cl. H02J 7/00; H01M 4/48; H01M 4/50; H01M 4/62; H02J 7/04; B05D 5/12

(52) U.S. Cl. 320/134; 429/231.1; 429/224; 429/217; 320/162; 427/122

(57) ABSTRACT

The methods and devices described herein generally relate to lithium-ion batteries, methods of preparing, and methods of operating such batteries. The lithium-ion batteries described herein have an improved cycle life. In one exemplary variation, the lithium-ion battery includes an anode including carbon-coated Li₄Ti₅O₁₂ particles and a cathode including LiMn₂O₄ particles, and the cathode capacity is larger than the anode capacity.

### STATEMENT REGARDING FEDERALLY SPONSORED RESEARCH OR DEVELOPMENT

Work for this patent application resulted from an NSF SBIR Phase II Grant No. 0522287 to Altair Nanomaterials Inc.

### CROSS REFERENCE TO RELATED APPLICATIONS

None

### NAMES OF PARTIES TO A JOINT RESEARCH AGREEMENT

Altair Nanomaterials Inc., Reno Nev.

Rutgers, The State University of New Jersey,

Hosokawa Micron International Inc.,

### BACKGROUND

1. Field

The methods and devices described herein generally relate to lithium-ion batteries, methods of preparing, and methods of operating such as batteries.

2. Related Art

Lithium manganate (i.e., LiMn₂O₄) has been considered a potential replacement for lithium cobaltate (i.e., LiCoO₂) in lithium-ion battery cathodes for over a decade. LiMnO₄-based cathodes -are about one-tenth the cost of LiCoO₂-based cathodes; they are safer to use, due to higher decomposition temperatures; and, they exhibit substantially lower toxicity profiles.

Such promising attributes of LiMnO₄-based cathodes, however, have been countered by a relatively low cycle-life that has undercut its use in commercial products. The cycle life problem originates from the interplay of at least two factors: 1) in bulk, Jahn-Teller distortion of the compound lattice produces electrochemical grinding; and, 2) manganese dissolution on the surface results in phase transformations and electrode passivation. These problems are exacerbated at elevated temperature, providing for rapid battery failure.

In 1998, Peramunage reported that a battery including a LiMn₂O₄ cathode could exhibit improved cycle life if the anode was based on lithium titanate (i.e., Li₄Ti₅O₁₂). Peramunage, D., J. Electrochem. Soc., 145, 2615-2622 (1998). The article discussed Li₄Ti₅O₁₂/PAN electrolyte/LiMn₂O₄ passivation free batteries with a cycle life of approximately 250 cycles and an energy density of 60 Wh/kg. A battery with a cycle life of 250 charge/recharge cycles, however, is not good enough for practical application, still leaving LiMn₂O₄ as a potential replacement for LiCoO₂ in cathodes.

Despite these past engineering efforts, there is still a need for lithium-ion batteries with increased cycle life.

### SUMMARY

The methods and devices described herein generally relate to lithium-ion batteries, methods of preparing, and methods of operating such batteries. The lithium-ion batteries described herein have an improved cycle life. In one exemplary variation, the lithium-ion battery includes an anode including carbon-coated Li₄Ti₅O₁₂ particles and a cathode including LiMn₂O₄ particles, and the cathode capacity is larger than the anode capacity.

### DESCRIPTION OF DRAWING FIGURES

FIG. 1 shows scanning electron microscopy (SEM) micrographs of the anode and cathode materials used in this invention: (a) Li₄Ti₅O₁₂ spherical particle of 5 μm average diameter: (b) surface of a Li₄Ti₅O₁₂ particle showing aggregated Li₄Ti₅O₁₂ crystallites with an average diameter of 20 nm; (c) LiMn₂O₄ spherical particle of ˜10 μm average diameter and 2 m²/g BET specific surface area; (d) surface of the same particle after calcination at 900° C. showing >500 nm average crystallite diameter and good self assembly; (e) particle size distribution (PSD) of 900° C. calcined particles before and after ultrasonication, proving fusion of the crystals together and 10 μm average particle diameter; (f) XRD characteristics of LiMn₂O₄ particles at various calcination temperatures.

FIG. 2 is a schematic of Hosokawa Mechano-Chemical Bonding Treatment used in the methods of the present invention.

FIG. 3 is a schematic of the cathode structure of the present invention.

FIG. 4 shows capacities as a function of number of cycles in the batteries of the present invention: (a) rate capability plots; (b) capacity fade at 3.2-1V, 20 C charge-discharge cycling for LMS1 cathodes and 10 C charge-discharge for L410 cathodes; (c) n-LTO capacity fade for 20 C charge-discharge, 3.2-1V room temperature (25° C.) cycling of five n-LTO/LMS1 samples of different matching ratios; (d) n-LTO capacity fade for 20 C charge-discharge, 3.2-1V room temperature (25° C.) cycling of five LTO/LMS1-1% samples of different matching ratios; (e) -LTO capacity fade for 20 C charge-discharge, 3.2-1V room temperature (25° C.) cycling of five LTO/LMS1-2% samples of different matching ratios.

FIG. 5 shows: (a) n-LTO capacity at 10 C charge-discharge versus TMR for all the cells made; (b) device gravimetric energy density at 10 C charge-discharge versus TMR for all the cells made; (c) device Ragone plots for n-LTO/LMS1, LMS1-1% and LMS1-2% with TMR ˜1 and TMR ˜2; (d) discharge voltage curves (1-80 C) for the devices LMS1#1&5; (e) derivatives of the charge-discharge voltage profiles at 1 C for the devices LMS1&5.

FIG. 6 shows the effect of matching ratio and battery laminate structure on capacity versus cycle number evolution during 20 C cycling at 25 or 55° C.

### DETAILED DESCRIPTION

In order to provide a more thorough understanding of the methods and devices described herein, the following description sets forth numerous specific details, such as methods, parameters, examples, and the like. It should be recognized, however, that such description is not intended as a limitation on the scope of the methods and devices described herein, but rather is intended to provide a better understanding of the possible variations.

### Definitions

The terms “crystallite” or “crystallites” refer to an object or objects of solid state matter that have the same structure as a single crystal. Solid state materials may be composed of aggregates of crystallites which form larger objects of solid state matter such as particles.

The terms “particle” or “particles” refer to an object or objects of solid state matter that are composed of aggregates of crystallites.

The methods and devices described herein generally relate to lithium-ion batteries with an anode/cathode configuration of Li₄Ti₅O₁₂/LiMn₂O₄ and methods of using such batteries which exploit the advantageous features of the LiMn₂O₄ spinel as a cathode material. Specifically, the methods and devices described herein provide Li₄Ti₅O₁₂/LiMn₂O₄ batteries having a cycle-life higher than any conventional Li₄Ti₅O₁₂/LiMn₂O₄ batteries so far reported. Many parameters with respect to the cathode and the anode of the Li₄Ti₅O₁₂/LiMn₂O₄ batteries may be adjusted to give optimum cycle life.

### Anode and Cathode Materials

The baseline anode material used in the various lithium ion-batteries described herein may be nano-sized Li₄Ti₅O₁₂ (LTO or n-LTO) produced by processes described in U.S. Pat. Nos. 6,881,393 and 6,890,510. These patents are incorporated-by-reference into this document for all purposes. The Li₄Ti₅O₁₂ material may be composed of a plurality of particles. Each particle of the plurality of particles may be composed of a plurality of crystallites. The Li₄Ti₅O₁₂ material may have a BET surface area of 5 m²/g to 150 m²/g, an average particle diameter of 100 nm to 5 μm, and an average crystallite diameter of 5 nm to 50 nm. In some variations, the Li₄Ti₅O₁₂ material may have a BET surface area of 10 m²/g to 125 m²/g. In other variations the Li₄Ti₅O₁₂ material may have a BET surface area of 25 m²/g to 100 m²/g or 50 m²/g to 90 m²/g.

Furthermore, as a baseline material for the cathode of the embodiments, the LiMn₂O₄ material may be composed of a plurality of particles. Each particle of the plurality of particles may be composed of a plurality of crystallites. The LiMn₂O₄ material may have a BET surface area of 0.5 to 10 m²/g, an average particle diameter of 1 to 25 μm, and an average crystallite diameter of 0.1 to 1.0 μm. In some variations, the LiMn₂O₄ material may have a BET surface area of 1.0 to 5.0 m²/g, an average particle diameter of 2.5 to 15 μm, and an average crystallite diameter of 0.2 to 0.8 μm.

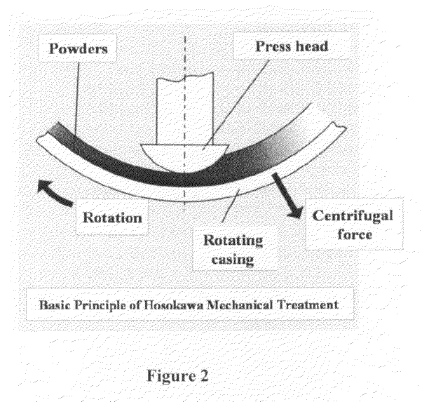

The cathode or anode particles may be carbon coated to form carbon-coated particles. A carbon coating technique known as Hosokawa Mechano-Chemical Bonding Technology may be used. This technique bonds particles together using only mechanical energy in a dry phase. The basic operating principle of Hosokawa Mechano-Chemical Bonding Technology is shown in FIG. 2. During the operation, the particles in the container are subjected to a centrifugal force and are securely pressed against the inner wall of rotating casing. The particles are further subjected to various mechanical forces, such as compression and shear forces, as they pass through a narrow gap between the casing wall and the press head. As a result, smaller guest particles are dispersed and bonded onto the surface of larger host particles without using binder of any kind. This is an environmentally friendly process to produce composite particles, especially nano-composites. In some variations, the Hosokawa Mechanical-Chemical Bonding Technology was applied to disperse carbon black and coat it onto the surfaces of nanosized Li₄Ti₅O₁₂ and LMS-1 particles.

### Preparation of Anode and Cathode

The anode and cathode of the lithium-ion battery may be prepared from anode and cathode compositions. The anode and cathode compositions may include a binder, an active material (Li₄Ti₅O₁₂ or LiMn₂O₄), and a conductive agent. For both the anode and the cathode, the binder may be poly-vinylidene fluoride hexafluoropropylene (PVDF-HFP), and the conductive agent may be a conductive carbon material such as carbon black. The anode composition may include 15 to 25 wt % binder, 65 to 75 wt % active material, and 5 to 15 wt % conductive agent. In one exemplary variation, the anode composition may include 20 wt % binder, 70 wt % active material, and 10 wt % conductive carbon. The cathode composition may include 20 to 30 wt % binder, 60 to 70 wt % active material, and 5 to 15 wt % conductive agent. In one exemplary variation, the cathode composition may include 25 wt % binder, 65 wt % active material, and 10 wt % conductive carbon.

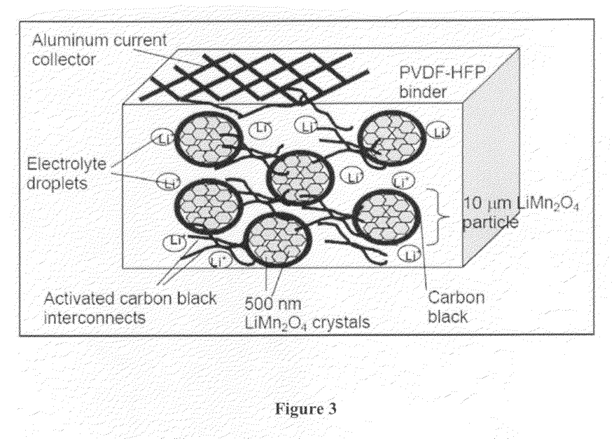

In some variations, carbon coating of the anode and/or cathode particles may provide interconnects with the carbon black to provide good electrical connection of the particles as shown schematically in FIG. 3.

### Method of Preparing Lithium-Ion Batteries

The lithium-ion batteries may be prepared by assembling the anode and cathode described above into a battery container with an electrolyte. The electrolyte may be composed of a solvent or mixture of solvents and a lithium salt or mixture of lithium salts. Examples of solvents which may be used include ethylene carbonate (EC), ethylene methyl carbonate (EMC), propylene carbonate (PC), butylene carbonate (BC), vinylene carbonate (VC), diethylene carbonate (DEC), dimethylene carbonate (DMC), γ-butyrolactone, sulfolane, methyl acetate (MA), methyl propionate (MP), and methylformate (MF), Acetonitrile (AN), methoxypropionitrile (MPN). Examples of lithium salts include LiBF₄, LiPF₆, LiAsF₆, LiClO₄, LiSbF₆, LiCF₃SO₃, and LiN(CF₃ SO₂)₂. In some variations, the electrolyte may include acetonitrile and LiBF₄. In some variations, the lithium-ion battery is prepared such that the capacity of the cathode is larger than the capacity of the anode as defined by a ratio of cathode capacity to anode capacity. The ratio of cathode capacity to anode capacity may be in the range of 1.2 to 2.1. The ratio may be 1.2, 1.4, 1.6, 1.8, 2.0, or 2.1. The lithium-ion battery may be configured to withstand at least 1000 cycles of charging and discharging and to have a discharge energy of 20 Wh/Kg at 2000 W/kg.

The lithium-ion battery may be operated by charging the lithium-ion battery up to 2.6 volts or up to 3.2 volts. The lithium-ion battery may then be discharged down to 1.0 volt.

### EXAMPLES

### Anode Material

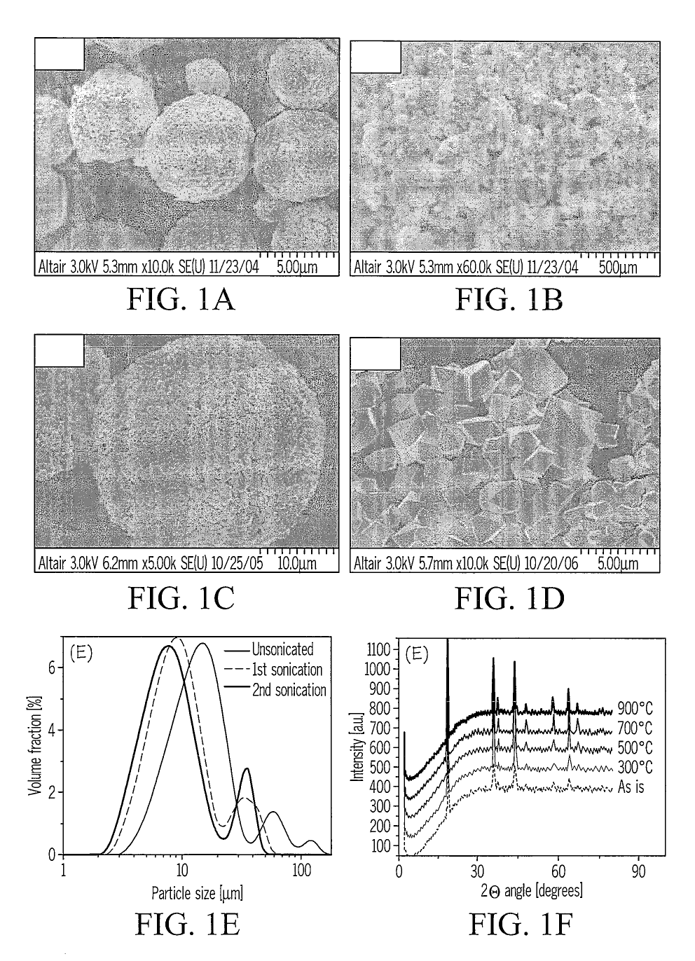

Nano-sized Li₄Ti₅O₁₂ having a BET specific surface area of 79 m²/g, an average spherical particle diameter of 5 μm, as shown in FIG. 1a, and an average crystallite diameter of 20 nm as shown in FIG. 1b was prepared as described in U.S. Pat. Nos. 6,881,393 and 6,890,510 and used as a baseline anode material.

### Cathode Material

A high power, doped grade of LiMn₂O₄ (LiCO L410) advertised for electric vehicle (EV) applications was used as a baseline cathode material. This material had an average particle diameter of 7-10 μm, a specific BET surface area of 1-3 m²/g, and a discharge capacity of 105 mAh/g. It is available in large quantities and low cost ($22/kg in 22 T shipments). ICP-AE via P&E Optima-3000DV elemental analysis showed that this material was Li rich and included several other metals.

Another LiMn₂O₄ spinel commercially available (Aldrich) was modified for use with a high rate LTO anode in other cases. ICP-AE based elemental analysis showed the same Li/Mn ratio as the L410 and a low level of Co doping (0.5 wt %, Mn basis). Both materials may be regarded as roughly equal low-dopant level, Li-rich compounds.

The particle size of the Aldrich LiMn₂O₄ material ($150/Kg) was first reduced to shards of about 50 nm. This resulted in a material of 30 m²/g specific BET surface area. The crystal shards were then spray-dried at 100° C. in a Buchi bench-top unit and annealed at various temperatures (400-900° C.). This resulted in grain growth and fusion of the crystals into spherical particles of 10 μm average diameter as shown in FIG. 1c and a specific BET area of 2 m²/g, but with primary crystallites having an average diameter of 500 nm as shown in FIG. 1d.

PSD analysis via Coulter LS230 confirmed the average particle diameter of 10 μm and stability, even after ultrasonication, indicating fusion of the primary crystals as shown in FIG. 1e. The maximum crystallinity was obtained at 900° C. as shown in FIG. 1f. The final LiMn₂O₄ material (LMS1) had similar average particle diameters and BET specific surface areas to those of the commercial LiMn₂O₄ material (L410), but an unusually even grain size of the primary particles and consistent macrostructure not normally found in commercial materials, and thus could be directly compared.

The nanosized Li₄Ti₅O₁₂ was carbon-coated with 2 wt % Super P (SP) carbon black (Timcal) to form carbon-coated Li₄Ti₅O₁₂ particles. The LiMn₂O₄ (LMS1) material was carbon-coated with 1 wt % and 2 wt % Super P carbon black, respectively, to form carbon-coated LiMn₂O₄ particles. These carbon-coated LiMn₂O₄ (LMS-1) materials will be referred to as LMS1-1% and LMS1-2%.

### Example 1

### Preparation of Anode and Cathode

The anode composition was prepared by combining 20 wt % PVDF-HFP, 70 wt % carbon-coated Li₄Ti₅O₁₂ particles, and 10 wt % SP carbon black. The cathode composition was prepared by combining 25 wt % PVDF-HFP, 65 wt % LiMn₂O₄ particles (LMS1) or carbon-coated LiMn₂O₄ particles (LMS1-1% or LMS1-2%), and 10 wt % SP carbon black. Slurries of the anode and cathode compositions were prepared. Table 1 summarizes exemplary compositions for the anode and cathode slurries. The slurry solvent for these examples is a mixture of propylene carbonate and acetone.

TABLE 1

| Anode | Cathode |
|---|---|
| 7 g of active material | 6.5 g of active material |
| 2 g Atofina 2801 PVDF-HFP | 2.5 g Atofina 2801 PVDF-HFP |
| 1 g SP carbon black | 1 g E350 carbon black |
| 5 g Propylene carbonate | 2.5 g Propylene carbonate |
| 30 g Acetone | 30 g Acetone |

After mixing for 10 minutes in a laboratory blender, the slurry was doctor-blade cast on a Mylar substrate, and electrodes were cut on the Mylar in 2×3 in² size. After being weighed, the electrodes were bonded by hot lamination at 120° C. to aluminum grids etched and spray-coated with Acheson adhesive conductive coating. This ensured good bonding and low impedance of the electrode-collector interface. The cells were assembled by lamination at 120° C. to a 25 μm Celgard microporous separator. They were of the bicell structure, which was: LTO/Al/LTO/sep/LMO/Al/LMO/sep/LTO/Al/LTO. They were dried overnight at 120° C. under vacuum in a glove box antechamber.

### Example 2

### Preparation of the Lithium-Ion Batteries

The electrodes prepared as described above were packaged into a battery container and activated in a helium filled glove box. The activation electrolyte consisted of 1.5 mL acetonitrile and 2 M LiBF₄ with less than 20 ppm water content.

### Example 3

### Cycle Tests of the Lithium-Ion Batteries

After preparation of batteries according to Example 2, the battery impedance was measured on a Solartron S11260 impedance analyzer between 10,000 and 0.01 Hz with 20 mV amplitude. The batteries were then transferred to a MACCOR4000 battery tester in a 25° C. environmental chamber for performance evaluation under the following testing protocol:
Discharge Ragone test: IC charges up to 3.2 V, 1, 5, 10, 20, 30, 40, 50, 60, 70, & 80 C discharges down to 1.0 V.
Charge Ragone test: 1, 5, 10, 20, 30, 40, 50, 60, 70, & 80 C charges up to 3.2 V, 1 C discharges down to 1.0 V.
Pause for impedance measurement
1,000 cycles with 20 C charges, 20 C discharges, 3.2-1 V voltage limits
Impedance measurement.

Since in most cases the cathode was in excess capacity, the rate capability is presented in mAh/g of the anode as a function of C-rate, calculated from the theoretical capacity of the device, whichever the limiting electrode was. The energy density calculations were performed on the basis of entire device weight (electrodes, collectors, separators, electrolyte) minus the packaging weight. The reason for subtracting the packaging weight is that, since only one small battery laminate was packaged, the weight fraction of the packaging material was about 30% of the entire device weight.

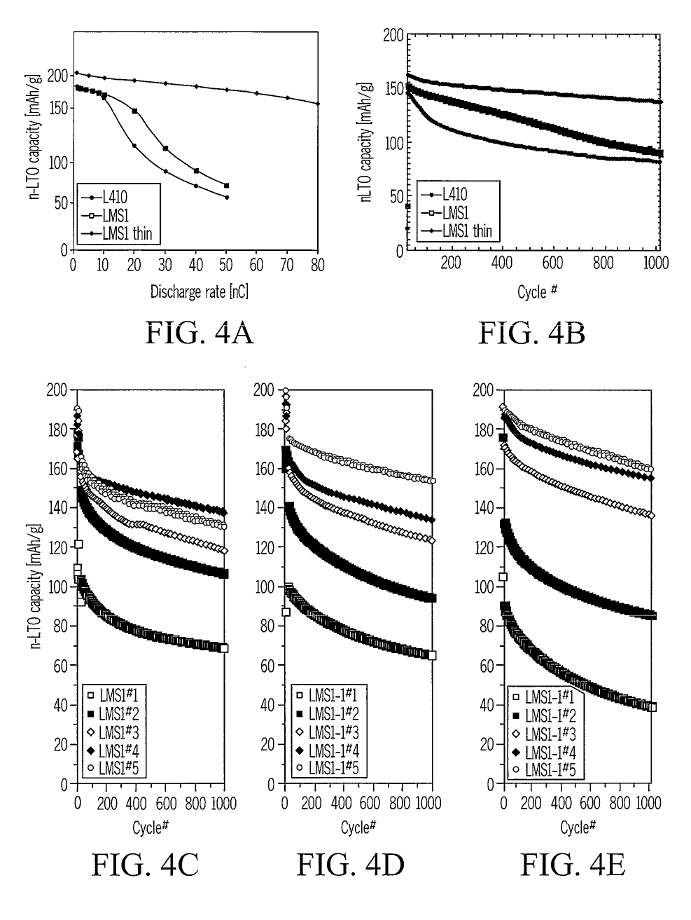

The comparison of rate capabilities and cycle-lives obtained with the two cathode materials L410 and LMS1 at the same matching ratio and electrode loading indicates clearly that LMS1 is the best choice for a high power device, as shown in FIG. 4a. By adopting this cathode material and reducing the anode thickness in half, another significant improvement in cycle-life and rate capability was achieved, as shown in FIG. 4b. In doing this, some energy density had to be sacrificed. Table 2 summarizes the effect of the electrode formulation and the thickness on energy density, and rate capability and cycle-life of the batteries.

TABLE 2

| | Electrode | Energy | | | |
|---|---|---|---|---|---|
| | loading | density | Matching | Rate | |
| Cathode | (mAh/cm²) | (Wh/kg) | Ratio | capability | Cycle-life |
| L410 | 1.21 | 51.5 | 1.54 | fair | fair |
| LMS1 | 1.1 | 52.5 | 1.47 | better | better |
| LMS1 thin | 0.57 | 41 | 1.81 | best | best |

Three series of batteries were prepared using either LMS1, LMS1-1% or LMS1-2% cathode with the same anode thickness and formulation. In each series, 5 different matching ratios were used ranging from 0.75 to 2 theoretical matching ratio (TMR) by changing the cathode thickness. Table 3 summaries the characteristics of the three series of batteries thus prepared.

TABLE 3

| | LTO* | | | | Cell |
|---|---|---|---|---|---|
| | (mAh/ | LMS | Capacity | TMR | Weight*** |
| Sample ID | cm²) | (mAh/cm²) | (mAh) | factor* | (g) |
| LMS1#1 | 0.579 | 0.859 | 33.5 | 0.75 | 4.74 |
| LMS1#2 | 0.579 | 1.18 | 44.8 | 1.03 | 5.12 |
| LMS1#3 | 0.579 | 1.38 | 44.8 | 1.2 | 5.08 |
| LMS1#4 | 0.579 | 2.10 | 44.8 | 1.81 | 5.5 |
| LMS1#5 | 0.602 | 2.49 | 44.8 | 2.06 | 5.67 |
| LMS1-1%#1 | 0.602 | 0.966 | 37.5 | 0.80 | 4.72 |
| LMS1-1%#2 | 0.602 | 1.23 | 46.6 | 1.02 | 4.89 |
| LMS1-1%#3 | 0.602 | 1.57 | 46.6 | 1.31 | 5.13 |
| LMS1-1%#4 | 0.602 | 1.93 | 46.6 | 1.61 | 5.51 |
| LMS1-1%#5 | 0.602 | 2.37 | 46.6 | 1.97 | 5.84 |
| LMS1-2%#1 | 0.602 | 0.877 | 33 | 0.70 | 4.76 |
| LMS1-2%#2 | 0.602 | 1.29 | 46.6 | 1.04 | 4.94 |
| LMS1-2%#3 | 0.602 | 1.66 | 46.6 | 1.34 | 5.29 |
| LMS1-2%#4 | 0.602 | 0.113 | 46.6 | 1.63 | 5.58 |
| LMS1-2%#5 | 0.602 | 0.137 | 46.6 | 1.98 | 5.77 |

Calculations are based on 160 mAh/g LTO, 111 mAh/g LMO.
*In the devices, the anode area is double the cathode area.
**TMR factor = Theoretic Matching Ratio factor = (cathode capacity/anode capacity)
***Includes packaging weight.

The cycle life of the materials was evaluated at 20 C charge-discharge rate over 1,000 cycles for all the batteries prepared with varying TMR factors. The voltage limits were 1-3.2V (5 s dwell) for all the samples. The curves of LTO capacity versus cycle number for LMS1, LMS1-1% and LMS1-2% cathode materials are respectively plotted on FIGS. 4c, 4d and 4e. The cycle-life increases when TMR increases, and a slight improvement with carbon coated cathodes is observed. The cycle abilities of these materials are rated as follows: LMS1-2%>LMS1-1%>LMS1. However, at the highest matching ratios, a rise in the capacity fade was observed. Without being limited by theory, this effect may be attributed to the damage done to the anode by pushing its voltage too low, which can cause Li alloying with the aluminum current collector.

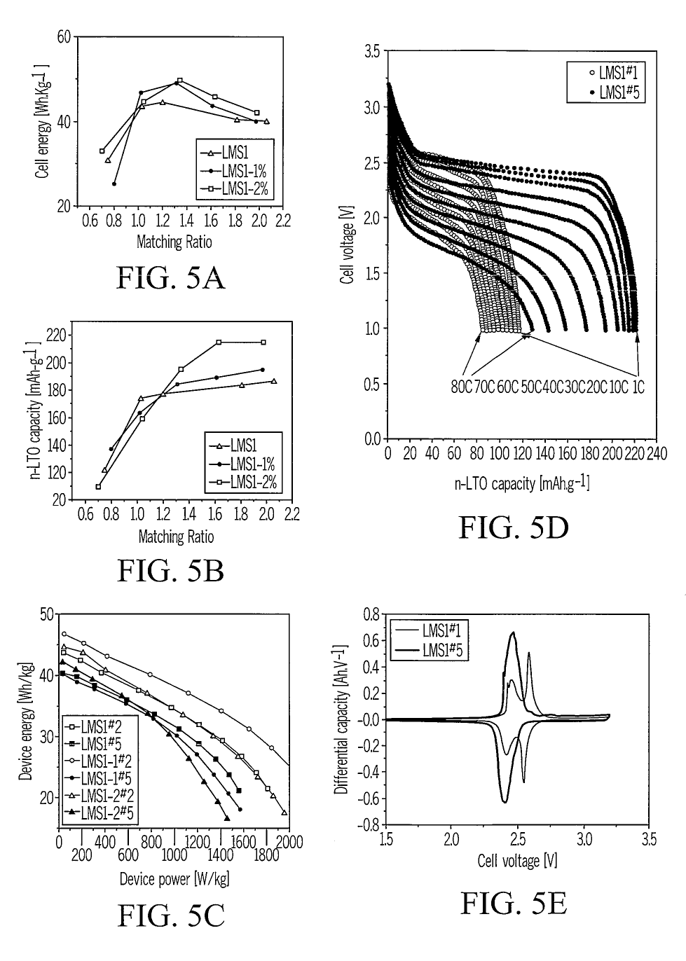

FIG. 5a indicates better anode utilization at higher matching ratios and at increased carbon contents. Surprisingly, the anode capacities measured were in some cases (high TMR and increased carbon coating contents) higher than the theoretical maximum of 174 mAh/g for LTO. This resulted in higher energy density for the carbon coated devices. The energy density of the devices (package weight not included) is optimal when TMR ˜1.3 enables the best utilization of both electrodes, as shown in FIG. 5b. Table 4 lists the highest values measured at 1 C charge-discharge rate for all the materials tested.

TABLE 4

| Cathode | TMR | Device energy @ 1 C [Wh/kg] |
|---|---|---|
| LMS1 | 1.2 | 44.7 |
| LMS1-1% | 1.31 | 49.0 |
| LMS1-2% | 1.34 | 49.8 |

The Ragone plots (specific energy versus specific power) are shown in FIG. 5c, expressed in Wh/kg versus W/kg for all the cells tested. At high discharge powers, 20 Wh/kg at 2000 W/kg average power on the entire discharge was measured for the best devices. Pulse discharge power, relevant for EV and HEV applications, is generally greater than average discharge power. However, the carbon coating is slightly detrimental to the high rate discharge capacity, and the change in slope of the Ragone plot is indicative of a diffusion limitation caused by the carbon coating, as shown in FIG. 5c. At high charging rates (beyond 30 C), all the samples displayed a change in the slope of the rate capability plots which indicates a diffusion limitation to the charge. However, the results indicate that a quasi full recharge can be performed at 20 C, i.e., 3 minutes (not shown in FIG. 5c).

An understanding of the improved cycle-life and the over-theoretical capacity measured can be derived from the voltage profiles. FIGS. 5d and 5e show discharge voltage curves (1-80 C) and their derivatives (1 C) for the devices LMS1#1 and #5 as defined in Table 3. For all the samples, two major differences are noticed between the low matching ratio cells (#1) and the high matching ratio cells (#5). On the derivative curves, only one peak is visible for charge and discharge at the high matching ratio, while two peaks are visible at the low matching ratio. This indicates only the first phase of LMS is being utilized at the high matching ratio. It also implies a lower charging voltage and lower lithium deintercalation, which results in better cathode cycle-life, and less outgassing. Secondly, at the high matching ratio there is a capacitive discharge from 3.2 to 2.6 Volts.

Many of the batteries described herein were made of inverted bicell laminates, that is anode/separator/cathode/separator/anode. For comparison, the batteries of some variations were of the bicell structure, that is cathode/separator/ anode/separator/cathode. In this case, the cathode area is doubled and the anode is halved. If the cathode is dominating the capacity fade, doubling its area should result in a lower capacity fade.

The cells were cycled at 20 C rate, either at 25 or 55° C. For comparison, two of the best cycling inverted bicells (LMS1#5 and LMS1-1%#5) were subjected to the standard cycling conditions (20 C, 3.2-1V), except for in a 55° C. chamber. This resulted in an acceleration of the capacity fade, which is a well known feature of the LiMn₂O₄ spinel. An improved cycle-life at 55° C. for the bicells was observed. Surprisingly, a good cycle-life for the bicell with TMR=1 at 25° C. was observed, dispelling the notion that the Jahn-Teller effect was the major cause of capacity fade for the LiMn₂O₄ spinel.

Without being limited by theory, the results may indicate that the major cause of capacity fade is the impedance increase on the cathode caused by the formation of a resistive layer which is exacerbated when the time spent at elevated temperature and higher voltage increases. With this regard, the cells with TMR=2 displayed less capacity fade at 55° C. because of their reduced charging voltage. Unfortunately, the bicells had a reduced power capability (despite slightly thinner electrodes) compared with the inverted bicells. This is caused by the fact that the LTO anode, due to its lower electronic conductivity, is indeed rate limiting the system. Thus, when the anode area is doubled as in the inverted bicell, better rate capability is obtained.

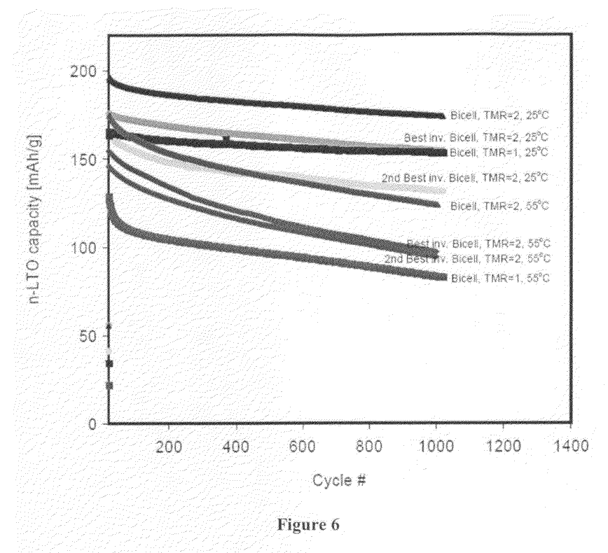

FIG. 6 shows the achievement of 1,000 elevated temperature cycles with less than 50% capacity fade over that cycling period. This is significant with a LMS cathode. In addition, there was no significant outgassing of the cells that were cycled at 55° C. (usually visible as ballooning of the soft packaging).

In the embodiments explained above, the nano-Li₄Ti₅O₁₂ /LiMn₂O₄ battery has been developed in a direction that favors high power delivery and excellent cycle life. The rate capability and the number of charge-discharge cycles are amongst the highest measured for this type of battery. At 80 C, the best devices still utilized 160 mAh/g of the anode, versus 190 mAh/g at 1 C. In terms of device power and energy, this translates to 49 Wh/kg at 50 W/kg, and 20 Wh/kg at 2000 W/kg.

When extra capacity was present in the cathode, it did not cause lithium plating and led to the over-theoretical double-layer capacitance causing a supercapacitor discharge voltage profile from 3.2V to 2.6V. This compensates for the loss in energy density caused by using thin electrodes. Large cathode excess (TMR 1.8 to 2) and carbon coating were also advantageous in increasing the cycle-life and anode utilization, with little penalty in energy density. Good cycle life was achieved, with 18.3 mAh/g n-LTO capacity fade over 1,000 cycles for TMR˜2 in the 1% carbon coated LMS1 cell. The elevated temperature cycling (55° C.) did not result in a dramatic capacity failure, but an increase in the fade slope, with steady and predictable behavior.

Not only a lower capacity fade but also a lower power capability was obtained with the bicell structure that has a cathode area twice as large as the anode area. In this case, excellent cycle-life was also obtained at room-temperature in the cells with a 1 to 1 capacity matching ratio. This indicates that low dopant LiMn₂O₄ spinel can be fully utlilized over extended numbers of fast cycles when the cathode passivation layer is not given enough time to grow.

These attributes described above, combined with an extremely fast charge capability (full charge possible in 3 min), make the device competitive for applications such as power tools and digital cameras. Especially, when designing protection circuits for the lithium-ion batteries which conventionally require monitoring and control of the voltage applied to the batteries in the order of 0.01 volts, the accurate control of the maximum voltage application by the protection circuit may be somewhat relieved by placing the maximum voltage in the supercapacitor voltage region, i.e., 3.2V to 2.6V.

For more demanding applications such as electric vehicles (EV) and hybrid electric vehicles (HEV), a wider temperature range is possible by the adoption of multi-component carbonate-based electrolytes, binders less prone to swelling, and high Co, Al or F doped manganese spinels with lowered Mn dissolution.

Although the methods and devices described herein have been described in connection with some embodiments or variations, it is not intended to be limited to the specific form set forth herein. Rather, the scope of the methods and devices described herein is limited only by the claims. Additionally, although a feature may appear to be described in connection with particular embodiments or variations, one skilled in the art would recognize that various features of the described embodiments or variations may be combined in accordance with the methods and devices described herein.

Furthermore, although individually listed, a plurality of means, elements or method steps may be implemented by, for example, a single devices or method. Additionally, although individual features may be included in different claims, these may be advantageously combined, and the inclusion in different claims does not imply that a combination of features is not feasible and/or advantageous. Also, the inclusion of a feature in one category of claims does not imply a limitation to this category, but rather the feature may be equally applicable to other claim categories, as appropriate.

Terms and phrases used in this document, and variations thereof, unless otherwise expressly stated, should be construed as open ended as opposed to limiting. As examples of the foregoing: the term “including” should be read to mean “including, without limitation” or the like; the terms “example” or “some variations” are used to provide exemplary instances of the item in discussion, not an exhaustive or limiting list thereof; and adjectives such as “conventional,” “traditional,” “normal,” “standard,” “known” and terms of similar meaning should not be construed as limiting the item described to a given time period or to an item available as of a given time, but instead should be read to encompass conventional, traditional, normal, or standard technologies that may be available or known now or at any time in the future. Likewise, a group of items linked with the conjunction “and” should not be read as requiring that each and every one of those items be present in the grouping, but rather should be read as “and/or” unless expressly stated otherwise. Similarly, a group of items linked with the conjunction “or” should not be read as requiring mutual exclusivity among that group, but rather should also be read as “and/or” unless expressly stated otherwise. Furthermore, although items, elements or components of methods and devices described herein may be described or claimed in the singular, the plural is contemplated to be within the scope thereof unless limitation to the singular is explicitly stated. The presence of broadening words and phrases such as “one or more,” “at least,” “but not limited to,” “in some variations” or other like phrases in some instances shall not be read to mean that the narrower case is intended or required in instances where such broadening phrases may be absent.

1. A lithium-ion battery comprising:
an anode comprising carbon-coated Li₄Ti₅O₁₂ particles; and
a cathode comprising LiMn₂O₄ particles;
wherein a capacity of the cathode is larger than a capacity of the anode.

2. The lithium-ion battery of claim 1, wherein a ratio of the capacity of the cathode to the capacity of the anode is in the range of 1.2 and 2.1.

3. The lithium-ion battery of claim 1, wherein the carbon-coated Li4Ti₅O₁₂ particles have a carbon content, and wherein the carbon content is less than 2% by weight of the carbon-coated Li₄Ti₅O₁₂ particles.

4. The lithium-ion battery of claim 1, wherein the LiMn₂O₄ particles are carbon-coated LiMn₂O₄ particles, and wherein the carbon-coated LiMn₂O₄ particles have a carbon content, and wherein the carbon content is 0.1 to 5% by weight.

5. The lithium-ion battery of claim 1, wherein an average diameter of the carbon-coated Li₄Ti₅O₁₂ particles is 100 nm to 5 μm, and an average diameter of the LiMn₂O₄ particles is 7 to 10 μm.

6. The lithium-ion battery of claim 1, wherein the anode further comprises a binder and a conductive agent.

7. The lithium-ion battery of claim 6, wherein the binder is poly-vinylidene fluoride hexafluoropropylene or poly-vinylidene fluoride and the conductive agent is conductive carbon, and wherein the binder is 15 to 25% by weight of the anode and the conductive agent is 5 to 15% by weight of the anode.

8. The lithium-ion battery of claim 7, wherein the carbon-coated Li₄Ti₅O₁₂ particles are 65 to 75% by weight of the anode.

9. The lithium-ion battery of claim 1, wherein the cathode further comprises a binder and a conductive agent.

10. The lithium-ion battery of claim 9, wherein the binder is poly-vinylidene fluoride hexafluoropropylene or poly-vinylidene fluoride and the conductive agent is conductive carbon, and wherein the binder is 20 to 30% by weight of the cathode and the conductive agent is 5 to 15% by weight of the cathode.

11. The lithium-ion battery of claim 10, wherein the LiMn₂O₄ particles are 60 to 70% by weight of the cathode.

12. The lithium-ion battery of claim 1, further comprising acetonitrile and LiBF₄.

13. The lithium-ion battery of claim 1, wherein the carbon-coated Li₄Ti₅O₁₂ particles have a BET specific surface area of 5 to 150 m²/g, and the LiMn₂O₄ particles have a BET specific surface area of 0.5-10 m²/g.

14. The lithium-ion battery of claim 1, wherein the carbon-coated Li₄Ti₅O₁₂ particles have an average crystallite diameter of 5 to 50 nm, and the LiMn₂O₄ particles have an average crystallite diameter of 0.1 to 1 μm.

15. The lithium-ion battery of claim 1, wherein the lithium-ion battery is configured to have a discharge energy of 20 to 60 Wh/Kg at a discharge power of 500-2000 W/Kg.

16. A method of operating a lithium-ion battery, the method comprising
charging the lithium-ion battery up to 2.6 volts;
wherein the lithium-ion battery comprises:
an anode comprising Li₄Ti₅O₁₂ particles and
a cathode comprising LiMn₂O₄ particles; and
wherein a capacity of the cathode is larger than a capacity of the anode.

17. The method of claim 16, wherein a ratio of the capacity of the cathode to the capacity of the anode is in the range of 1.2 to 2.1.

18. The method of claim 16, wherein the lithium-ion battery is charged to a voltage ranging from 2.6 to 3.2 volts.

19. The method of claim 16, further comprising discharging the lithium-ion battery down to 1.0 volt.

20. The method of claim 16, wherein the Li₄Ti₅O₁₂ particles are carbon-coated Li₄Ti₅O₁₂ particles.

21. The method of claim 20, wherein the carbon-coated Li₄Ti₅O₁₂ particles have a carbon content, and wherein the carbon content is up to 2% by weight of the carbon-coated Li₄Ti₅O₁₂ particles.

22. The method of claim 20, wherein the LiMn₂O₄ particles are carbon-coated LiMn₂O₄ particles, and wherein the carbon-coated LiMn₂O₄ particles have a carbon content, and wherein the carbon content is 0.1 to 5% by weight carbon-coated LiMn₂O₄ particles

23. The method of claim 20, wherein an average diameter of the carbon-coated Li₄Ti₅O₁₂ particles is 100 nm to 5 μm, and an average diameter of the LiMn₂O₄ particles is 7 to 10 μm.

24. The method of claim 20, wherein the anode further comprises a binder and a conductive agent.

25. The method of claim 24, wherein the binder is poly-vinylidene fluoride hexafluoropropylene and the conductive agent is conductive carbon, and wherein the binder is 15 to 25% by weight of the anode and the conductive agent is 5 to 15% by weight of the anode.

26. The method of claim 25, wherein the carbon-coated Li₄Ti₅O₁₂ particles are 65 to 75% by weight of the anode.

27. The method of claim 20, wherein the cathode further comprises a binder and a conductive agent.

28. The method of claim 27, wherein the binder is poly-vinylidene fluoride hexafluoropropylene and the conductive agent is conductive carbon, and wherein the binder is 20 to 30% by weight of the cathode and the conductive agent is 5 to 15% by weight of the cathode.

29. The method of claim 28, wherein the LiMn₂O₄ particles are 60 to 70% by weight of the cathode.

30. The method of claim 20, wherein the carbon-coated Li₄Ti₅O₁₂ particles comprise particles corresponding to a BET specific surface area of 5 to 150 m²/g, and the LiMn₂O₄ particles comprise particles corresponding to BET specific surface area of 0.5-10 m²/g.

31. The method of claim 20, wherein the carbon-coated Li₄Ti₅O₁₂ particles comprise particles having an average crystallite diameter of 5 to 50 nm, and the LiMn₂O₄ particles comprise particles having an average crystallite diameter of 0.1 to 1 μm.

32. A method of making a lithium-ion battery, comprising:
providing Li₄Ti₅O₁₂ particles having a BET specific surface area of 5 to 150 m²/g;
providing LiMn₂O₄ particles having a BET specific surface area of 0.5-10 m²/g;
carbon-coating the Li₄Ti₅O₁₂ particles to form carbon-coated Li₄Ti₅O₁₂ particles with a carbon content up to 2% by weight;
forming an anode comprising the carbon-coated Li₄Ti₅O₁₂ particles, a binder, and a conductive agent;
forming a cathode comprising the LiMn₂O₄ particles, a binder and a conductive agent; and
wherein a capacity of the cathode is larger than a capacity of the anode.

33. The method of claim 32, further comprising carbon-coating the LiMn₂O₄ particles.

34. The method of claim 32, wherein the carbon-coating of the Li₄Ti₅O₁₂ particles is performed by applying a force.

35. The method of claim 32, further comprising immersing the anode and the cathode in an electrolyte comprising acetonitrile and LiBF₄.
